(19) United States
(12) Patent Application Publication
(10) Pub. No.: US 2004/0021904 A1
(43) Pub. Date: Feb. 5, 2004

(54) Device for printing and archiving images

(76) Inventors: Vincent C. Skurdal, Boise, ID (US); Mark L. Brown, Boise, ID (US); Marvin Duane Nelson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/209,478

(22) Filed: Jul. 30, 2002

(51) Int. Cl. G06F 12/16; G06F 17/30; G06F 13/00

(52) U.S. Cl. 358/1.16; 707/204; 358/1.15

(57) ABSTRACT

A system for facilitating image archival. The system includes a printer for receiving data and selectively printing the data on a first medium based on one or more predetermined parameters. An archiving system disposed within the printer automatically archives the data via a second medium based on the predetermined parameters. In a more specific embodiment, the printer is a photo printer that includes a controller for controlling image printing and image archiving operations performed by the printer and the archiving system based on the one or more predetermined parameters, which are programmable. The photo printer includes a user-interface that accepts user-input for programming said predetermined parameters. The archiving system includes a compact disk writer. The electronic storage medium includes a compact disk. In an alternative embodiment, the archiving system includes software and communications links for connecting to an archival website to store the image data.

### BACKGROUND OF THE INVENTION

1. Field of Invention

The present invention relates to image printing systems. Specifically, the present invention relates to image printing systems that can both print and electronically archive images.

2. Description of the Related Art

Photographic printing systems are employed in various demanding applications including legal documentation and general photographic development. Such applications require cost-effective and versatile photo printers that can efficiently receive, print, and archive images.

An exemplary conventional photographic printing system includes a personal computer (PC) connected to a printer and a scanner. Special image editing software, scanning software, and/or printer drivers are required to print images and archive them on a hard disk, CDRW (Compact Disk Read and Write), or other storage media. Unfortunately, such systems are often prohibitively expensive and too bulky for many applications.

To address these shortcomings, photographic printing devices (photo printers) incorporating scanners, memory card slots, and printers have been developed. Such printing systems often include additional infrared (IR) ports, USB ports, or other mechanisms for communicating digital images to be printed. These printing systems are often incorporated into All-In-One (AIO) devices that include faxing and other capabilities. Unfortunately, conventional photo printers and AIO devices typically require a personal computer to efficiently archive scanned images or images retrieved from a memory card.

Hence, a need exists in the art for an efficient photo printer that facilitates both image printing and image archival without requiring an additional PC. There exists a further need for a versatile PC-connectable system capable of sharing functionality with a PC.

### SUMMARY OF THE INVENTION

The need in the art is addressed by the system for storing data of the present invention. The system includes a printer that receives image data and selectively prints the imaged data based on one or more predetermined parameters. An archiving system is disposed within the printer and selectively automatically archives the image data via an electronic storage medium based on the predetermined parameters.

In a more specific embodiment, the printer is a photo printer that includes a controller for controlling image printing and image archiving operations performed by the printer and the archiving system based on the one or more predetermined parameters. The photo printer includes a user-interface that accepts user-input to adjust the one or more predetermined parameters. The archiving system includes a compact disk writer, and the electronic storage medium includes a compact disk.

In an alternative embodiment, the archiving system includes software and communications links for connecting to an external archive to store the image data. The external archive is an archival website, which is automatically accessible via the archiving system.

The novel design of the present invention is facilitated by the archiving system, which enables both image archiving and printing functionality to coexist in a single compact and portable unit. The synergistic combination of a photo printer with a mechanism to optionally archive images eliminates the need to purchase bulky and expensive components, such as computers, and eliminates the need to perform complex and time consuming steps required to both archive and print images. This printing-archiving combination significantly increases the usefulness of the photo printer, especially in applications requiring both photographic printing and photo organization.

### BRIEF DESCRIPTION OF THE DRAWINGS

FIG. 1 is a diagram of a combination image printing and archival system constructed in accordance with the teachings of the present invention.

FIG. 2 is a diagram of an alternative embodiment of the image printing and archival system of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

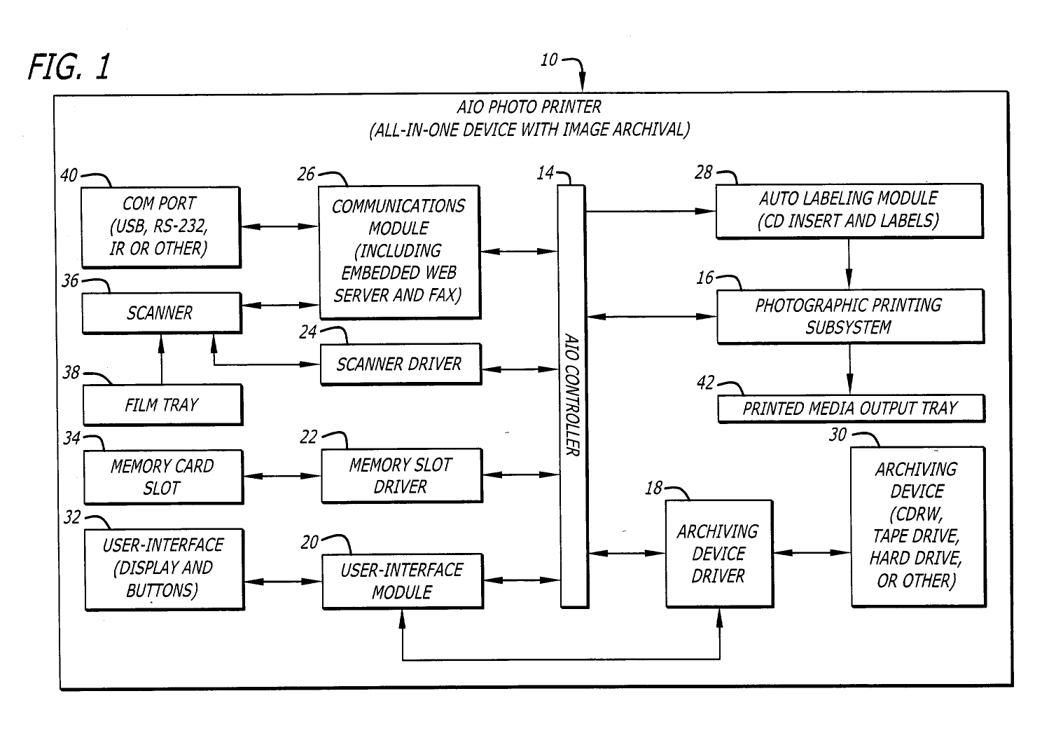

FIG. 1 is a diagram illustrating an embodiment of a combination image printing and archival system 10 constructed in accordance with the teachings of the present invention. For clarity, various well-known components, such as power supplies, laser-printing system components, operating systems, and so on have been omitted from the figures. However, those skilled in the art with access to the present teachings will know which components to implement and how to implement them to meet the needs of a given application.

In the present specific embodiment, the printing and archival system 10 is implemented as an All-In-One (AIO) photo printer 10. The unique photo printer 10 includes an AIO controller 14 in communication with a photographic printing subsystem 16, an archiving device driver 18, a user-interface module 20, a memory slot driver 22, a scanner driver 24, a communications module 26, and an automatic labeling module 28. The automatic labeling module 28 provides output to the photographic printing subsystem 16, which includes various printer components, such as an electrophotographic drum, laser, developer, and so on, (not shown) required to print photos on output media yielding printed media at output tray 42. The photographic printing subsystem 16 may be implemented as a printing system other than an electrophotographic printing system, such as an inkjet printing system, without departing from the scope of the present invention. Various applicable printing systems are known in the art.

The archiving device driver 18 communicates with an archiving device 30 to facilitate image archival. The archiving device 30 may be implemented as a CDRW, tape drive, hard drive, DVD-R, DVD-RAM or other archiving device. In the preferred embodiment, the archiving device 30 archives data to a removable storage medium, such as a CD.

The archiving device driver 18 optionally communicates directly with the user-interface module 20. The user-interface module 20 receives input from a user-interface 32, which includes buttons, display screens, and/or other mechanisms, such as digital pens, mice, or microphones, (not shown) to facilitate user input.

The memory slot driver 22 communicates with a memory card slot 34 to facilitate image data retrieval from the slot 34. The scanner driver 24 communicates with a scanner 36, which receives input via a film tray 38. The scanner 36 may communicate with the communications module 26 to facilitate faxing operations. The communications module 26 controls a corn port 40, which may connect to an external image source, such as the Internet, to retrieve image data.

The corn port 40 may be implemented via a Universal Serial Bus, RS-232, Ethernet, Blue Tooth, infrared (IR) or other type of connection. Furthermore, additional com ports may be incorporated into the photo printer 10 without departing from the scope of the present invention.

In the present specific embodiment, the communications module 26, the scanner driver 24, the memory slot driver 22, the user-interface module 20, the archiving device driver 18, the archiving device 30, the AIO controller 14, and the auto-labeling module 28 are implemented in software running on a computer (not shown) incorporated in the photo printer 10. The various software modules may be constructed by one skilled in the art with access to the present teachings, without undue experimentation.

In operation, a user may employ the photo printer 10 to both print and archive images. A user employs the user-interface 32 to configure the photo printer 10 to print and/or archive images. The user-interface 32 includes various buttons and a display (not shown) for providing various user options in accordance with a user-interface algorithm running on the user-interface module 20. Exact details of the user-interface options and associated algorithm are application-specific and may be determined by one skilled in the art to meet the needs of a given application.

In the present embodiment, the user-interface module 20 acts as a driver for user-interface hardware 32, such as buttons and displays, and provides user options via the user-interface 32. The user options, which may be displayed to the user in a menu format, include whether to scan images via the scanner 36, retrieve images from the memory card slot 34, or to retrieve image data via infrared, USB, RS-232 or other types of connections. Additional user options specify whether to print the retrieved images, archive the retrieved images on a CD, print a CD label or jewel case insert with predetermined user-selected content, and/or archive the images via an external mechanism connected to the corn port 40. The user-interface module 20 may provide additional and/or different user options without departing from the scope of the present invention.

The corn port 40 may connect directly to a PC (not shown). Appropriate photo printer drivers are installed on the PC to allow the PC to use functionality of the photo printer, such as functionality provided by the archiving device 30 or the scanner 36. Those skilled in the art with access to the present teachings will know how to construct appropriate drivers to meet the needs of a given implementation.

In a first exemplary scenario, a user selects, via the user-interface 32, to scan images, print the images, archive the images, and then automatically print a CD label for any images archived via the archiving device 30 on CD. Corresponding configuration information is provided to the user-interface module 20 via the user-interface 32. The user-interface module 20 provides the configuration information to the AIO controller 14. The AIO controller 14 then activates the scanner driver 24 in preparation for scanning and notifies the user via the user-interface module 20 and user-interface 32 that the scanner is ready to scan. The user then places one or more images in the scanner 36 and activates scanning via the user-interface 32, such as by pressing an appropriate user-interface button. The scanner 36 then scans images placed in the film tray 38. The scanned images are stored temporarily via memory (not shown) associated with the AIO controller 14 before they are printed and archived. The user may name scanned images via the user-interface 32.

Alternatively, the AIO controller scanner 36 and scanner driver 24 are configured to automatically scan after film or other input media is placed into the film tray 38 associated with the scanner 36. Automatic scanning functionality may be user-configurable via the user-interface 32 and user-interface module 20.

In the present exemplary scenario, the AIO controller 14 forwards the scanned images to the photographic printing subsystem 16, which includes printer drivers and mechanisms for printing electronically stored images. Such printing mechanisms are well known in the art.

The automatic labeling module 28 tracks images forwarded to the photographic printing subsystem 16 and the archiving device driver 18 that are to be archived onto CD via the archiving device 30. The automatic labeling module 28 forwards the names of images to be archived on each CD to the photographic printing subsystem 16, which automatically prints the appropriate CD labels containing names corresponding to images to be archived on each CD. Labels other than CD labels, such as tape disk labels and corresponding inserts, may be printed instead of CD labels depending on user options chosen via the user-interface 32.

The AIO controller 14 forwards scanned image data to the archiving device driver 18. The device driver 18 then writes the image data to a CD in response to control signals received from the archiving device driver 18. The control signals may be optionally adjusted and configured via the user-interface 32 and user-interface module 20. A CD label that lists names and/or thumbnails of images stored on the CD is printed by the photographic printing subsystem 16 and output to the printed media output tray 42. The automatic labeling module 28, the photographic printing subsystem 16, the archiving device driver 18, and the archiving device 30 comprise a data output subsystem.

In a different scenario, the AIO controller 14 employs the memory slot driver 22 to retrieve image data from a flash card, memory stick, or other memory device inserted into the memory card slot 34. In yet another scenario, the AIO controller 14 employs the communications module 26 to retrieve image data via an infrared connection to a portable device, such as another photo printer or handheld device, or other computing device. A user may configure the AIO controller 14 to retrieve image data via the scanner driver 24, the memory slot driver 22, or the communications module 26, via the user-interface 32 and user-interface module 20.

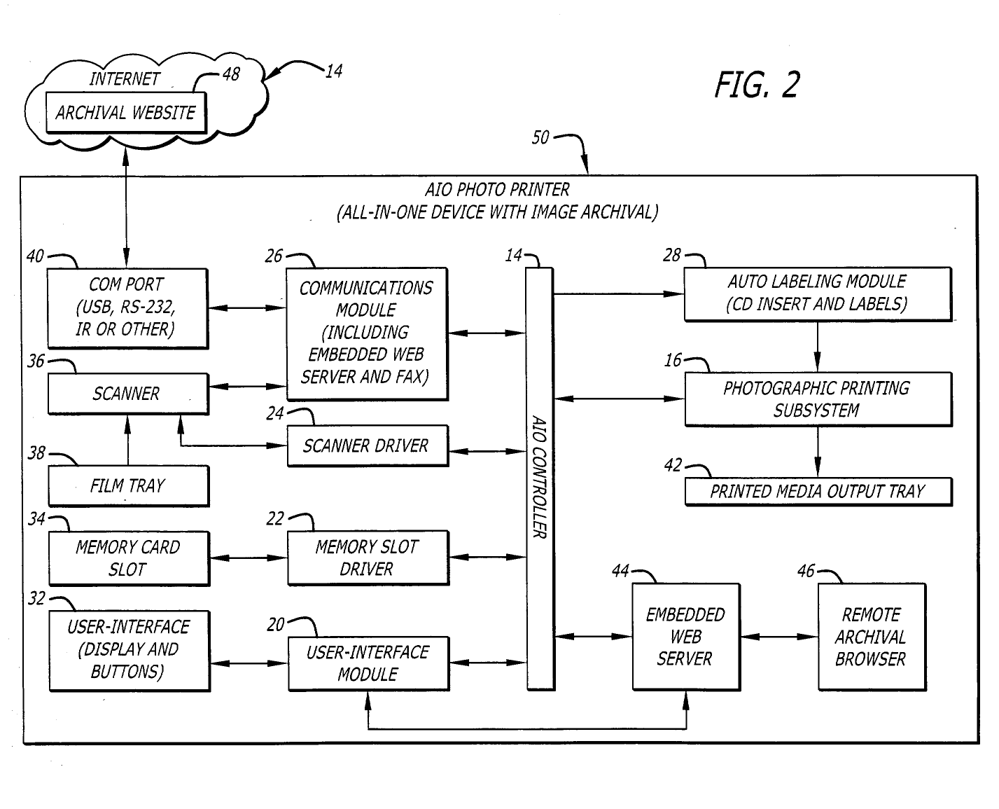

FIG. 2 is a diagram of an alternative embodiment 50 of the image printing and archiving system 10 of FIG. 1. The printing and archiving system 50 of FIG. 2 is similar to the printing and archiving system 10 of FIG. 1 with the exception that the archiving device driver 18 and archiving device 30 of FIG. 1 are replaced with an embedded web server 44 and a remote archival browser 46 to facilitate Internet-based image archival via an archival website 48 on the Internet 14. In the embodiment of FIG. 2, the embedded web server 44, the remote archival browser 46, the communications module 26 and 40, the automatic labeling module 28, and the photographic printing subsystem 16 comprise a data output subsystem.

The corn port 40 is employed to connect to the Internet 14. The embedded web server 44 includes software for facilitating image uploading to the archival website 48. The web server 44 employs the AIO controller 14 to activate the communications module 26, causing the corn port 40 to connect to the Internet 14. A user may then browse the Internet 14 via the user-interface 32, user-interface module 20, and remote archival browser 46. The AIO photo printer 50 and browser 46 may be configured to automatically archive input images on the remote website 48 via a direct Internet connection. Those skilled in the art will appreciate that the server 44 for uploading images to the archival website 48 may be incorporated into the remote archival browser 46.

The remote archival browser 46 is configurable via the user-interface 32 and user-interface module 20. For example, a user may configure the remote archival browser 46 to automatically browse to the archival website 48 by default when an Internet connection is established. The remote archival browser 46 may directly communicate with the user-interface module 20. Alternatively, the browser 46 may be configured by the AIO controller 14 in response to configuration information retrieved from the user-interface module 20.

Those skilled in the art will appreciate that the archiving device driver 18 and associated archiving device 30 of FIG. 1 may be incorporated into the AIO photo printer 50 of FIG. 2 without departing from the scope of the present invention. In this case, the user is provided with an additional image archival options, such as whether to archive images via the archiving device 30 of FIG. 1.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

What is claimed is:

1. A system for storing data comprising:
a printer that receives data and selectively prints said data on a first storage medium based on one or more predetermined parameters and an archiving system disposed within said printer that selectively automatically
archives said data via a second storage medium based on said predetermined parameters.

2. The system of claim 1 wherein said data is image data; said first storage medium is paper or transparency; and said second storage medium is an electronic storage medium.

3. The system of claim 2 wherein said printer includes a controller for controlling image printing and image archiving operations performed by said printer and said archiving system based on said one or more predetermined parameters.

4. The system of claim 3 wherein said printer is a photo printer that includes a user-interface that accepts user-input to adjust said one or more predetermined parameters.

5. The system of claim 4 wherein said archiving system includes a compact disk writer, and said electronic storage medium includes a compact disk.

6. The system of claim 4 wherein said archiving system includes software and communications links for connecting to an external archive to store said image data.

7. The system of claim 6 wherein said external archive is an archival website.

8. A printer facilitating data archival comprising:
first means for receiving data and printing said data in response to a control signal;
second means for generating said control signal based on predetermined parameters; and
third means for automatically adding said data to an archive in response to said control signal.

9. A photo printer for archiving data comprising:
first means for receiving data and printing said data;
second means for automatically archiving said data; and
third mean controlling said first means and said second means in accordance with predetermined parameters.

10. The photo printer of claim 9 wherein said predetermined parameters are user-programmable.

11. A system for storing data comprising:
a photo printer that receives image data via a data link or built-in scanner and selectively prints said imaged data based on one or more predetermined parameters and provides printed image data in response thereto;
an archiving system disposed within said printer that selectively automatically archives said image data via a compact disk based on said one or more predetermined parameters; and
a controller disposed within said printer that controls image printing and image archiving operations performed by said printer and said archiving system based on said one or more predetermined parameters.

12. A unit for facilitating image archival comprising:
first means for receiving image data;
second means for accessing predetermined parameters pertaining to said image data; and
third means for producing a printed hardcopy of said image data and/or archiving said image data based on said predetermined parameters, said first, second, and third means disposed within a single device.

13. The unit of claim 12 wherein said first means includes a data input mechanism for accepting said image data and maintaining said image data in an electronic state; said second means includes an internal user-interface for accepting said user input corresponding to said predetermined parameters; and said third means including an internal data output subsystem for producing a printed hardcopy of said image data and/or selectively storing said image data on a memory device based on said user input.

14. The unit of claim 13 wherein said single device is a photo printer, and wherein said data output subsystem includes a photographic printing subsystem that selectively prints said image data based on said user input.

15. The unit of claim 14 wherein said data output subsystem includes a Compact Disk Read/Write (CDRW) drive that selectively stores said image data on a CDRW disk based on said user input.

16. The unit of claim 15 wherein said data input mechanism includes a scanner, an infrared port, a Universal Serial Bus (USB), a memory slot, an attached memory disk reader, and/or an Internet connection.

17. The unit of claim 15 wherein said memory device includes an automatic labeling module that selectively prints a jewel case insert and/or Compact Disk (CD) label.

18. The unit of claim 17 wherein said jewel case insert and/or CD label lists names of images and/or thumbnails comprising said image data, said image data stored on a CD that is inserted into said CDRW drive.

19. The unit of claim 12 wherein said third means includes an internal memory device.

20. The unit of claim 12 wherein said third means includes an archival website.

21. The unit of claim 13 wherein said data output subsystem includes an embedded web server and an Internet connection that connects to a remote Internet storage location associated with said memory device.

22. A system for facilitating image printing and archiving comprising:
first means for receiving an image for printing and providing a first signal in response thereto;
second means for selectively archiving said image based on said first signal and providing a second signal in response thereto; and
third means for printing said image in response to said second signal.

23. A system for facilitating image printing and archiving comprising:
first means for receiving an image for printing and providing a first signal in response thereto;
second means for printing said image in response to said first signal and providing a second signal in response thereto; and
third means for selectively archiving said image based on said second signal.

24. The system of claim 23 further including a user-interface for receiving configuration information from a user, said configuration information affecting the operation of said second means and said third means.

25. The system of claim 23 wherein said third means includes means for archiving said image data via a removable storage medium.

26. A system for facilitating image printing and archiving comprising:
a data input mechanism that accepts image data and maintains said image data in an electronic state;
an internal interface that accepts configuration parameters; and
an internal data output subsystem connected to said data input mechanism and said internal interface that prints a hardcopy of said image data and/or selectively stores said image data on an internal or external memory device based on said configuration parameters.

27. A method for facilitating image archiving and printing comprising the steps of:
accepting image data and maintaining said image data in an electronic state via a multi-function photo printer;
accessing configuration information pertaining to said image data; and
producing a printed hardcopy of said image data and/or storing said image data via a memory device included in said multi-function photo printer based on said configuration information.
